(19) United States
(12) Patent Application Publication
(10) Pub. No.: US 2010/0023515 A1
(43) Pub. Date: Jan. 28, 2010

(54) DATA CLUSTERING ENGINE

(76) Inventor: Andreas Marx, Oakville (CA)

Correspondence Address: HEENAN BLAIKIE LLP, BAY ADELAIDE CENTRE, 333 BAY STREET, SUITE 2900, P.O. BOX 2900, TORONTO, ON, M5H 2T4, CA

(21) Appl. No.: 12/181,053

(22) Filed: Jul. 28, 2008

(51) Int. Cl. G06F 17/30

(52) U.S. Cl. 707/6; 707/E17.005; 707/E17.014; 707/200; 707/E17.046

(57) ABSTRACT

A method of managing a plurality of records, in which each record comprises a plurality of fields, involves determining a match signature for each record by evaluating a deterministic cluster definition against each record. The deterministic cluster definition comprises a logical association of the fields and defines at least one data cluster of the records. The data clusters are then identified by populating a match table with the match signatures. Each match signature is unique within the match table. Each record is associated with a respective one of the match signatures that are populated in the match table.

### FIELD

This invention relates to database management. In particular, this invention relates to a method and system for identifying related records in a database.

### BACKGROUND

Conventional database management systems typically use deterministic or probabilistic matching to identify related records in a database. Deterministic matching determines whether a test string of characters matches a record of the database by assessing the degree of similarity between the test string and a string of characters in each record of the database, and then evaluating the similarities against one or more rules to identify the record that matches the test string.

Gruenwald (US 2003/037051) describes a deterministic approach to identify duplicate data. Raw data is converted from its original form (e.g. alphanumeric, numeric) to numeric form, and then sorted the numeric data into sets based on sorting criteria, such as surname. The sorted data is then partitioned into sets, such that the data records in each set have, for example, the same surname. Duplicate data records in a data set are identified by using a correlation function (e.g. dot product) to determine the degree of similarity between pairs of the data records in the data set.

Shipley (US 2007/071240) also describes a deterministic approach to identify duplicate data in a data set. Each data element in the data set is divided into a series of data segments. An intermediate value is calculated for each data element by summing the value of each data segment. The data elements are sorted into groups according to their respective intermediate values. Duplicate data elements are identified by comparing the data segments of the data elements in each group.

Probabilistic matching uses statistical information associated with the uniqueness and frequency of occurrence of character strings in the database to determine whether a test string of characters matches a record of the database. Using the statistical information of the character strings in the database, for each record in the database a probabilistic algorithm calculates the probability of the test string of characters matching the string of characters in the associated field of the database record. The algorithm identifies the closest matching record based on the match probability for each database record.

Ganti (US 2007/005556) describes a probabilistic approach to identify duplicate data. Tuples are converted into a hash vector, with each field of the tuple being hashed to generate a corresponding hash value for the hash vector. Candidate tuples are identified by sorting the hash vectors such that tuples that share the same hash value for a given field will cluster together during sorting. Tuple pairs are identified by comparing pairs of the candidate tuples using a probabilistic similarity function.

The probabilistic matching algorithm is more computationally expensive than deterministic matching algorithm. Therefore, deterministic matching is often favoured for large data sets. On the other hand, probabilistic matching is more accurate than deterministic matching. Therefore, probabilistic matching is often favoured where accuracy of the data match is paramount.

As a consequence of these divergent characteristics, there is a need for a method of database management that can accurately identify related records in large data sets on computationally-constrained computing platforms.

### SUMMARY

The invention described herein identifies data clusters amongst a plurality of data records by evaluating a deterministic cluster definition against each record.

In one aspect of this disclosure, there is described a data clustering engine that comprises a match signature processor, and a match table processor that is coupled to the match signature processor. The match signature processor is configured for communication with a database that comprises a plurality of records, with each said record comprising a plurality of fields. The match signature processor is configured to determine a match signature for each record by evaluating a deterministic cluster definition against each said record. The deterministic cluster definition comprises a logical association of the fields and defines at least one data cluster of the plurality of the data records.

The match table processor is configured for communication with a match table and to identify the data clusters by populating the match table with the match signatures such that each said populated record is unique within the match table, and each record of the plurality of records is associated with a respective one of the match signatures populated in the match table.

In another aspect of this disclosure, there is described a computer-readable medium carrying computer processing instructions which, when executed by a computer, cause the computer to perform as follows:
determine a match signature for each said record of a plurality of records by evaluating against each record a deterministic cluster definition that comprises a logical association of the fields and defines at least one data cluster of the plurality of the records; and
identify the data clusters amongst the plurality of records by populating a match table with the match signatures, each populated match signature being unique within the match table, each record of the plurality of records being associated with a respective one of the match signatures populated in the match table.

In another aspect of this disclosure, there is described a method of managing a plurality of records, in which each record comprises a plurality of fields. The method involves determining a match signature for each record of the plurality of records by evaluating a deterministic cluster definition against each record. The deterministic cluster definition comprises a logical association of the fields, and defines at least one data cluster of the plurality of the records. The data clusters are identified amongst the plurality of records by populating a match table with the match signatures. Each match signature is unique within the match table. Each record of the plurality of records is associated with a respective one of the match signatures that is populated in the match table.

The logical association may comprise a logical AND association of at least two of the fields, a logical OR association of at least two of the fields, or both. The match signature determining may comprise, prior to the cluster definition evaluating, encoding character strings contained in the fields to reduce the edit distance between similar strings. A suitable form of character string encoding comprises phonetic match encoding.

In one implementation, the match table comprises a plurality of match sub-tables, and at least one of the match sub-tables is uniquely associated with a respective logical AND association. Each match sub-table is populated with at least one of the match signatures. Each match signature of the respective match sub-table is determined from a respective logical AND association via the deterministic cluster definition, and is maintained in the match sub-table that is uniquely associated with the logical AND association.

In this implementation, the match signature may be determined for the one record by evaluating a respective logical AND association against the one record. The data cluster may be identified by, for each determined match signature of the one record, searching the respective match sub-table for a sub-table entry matching the determined match signature, and updating the respective match sub-table with the match signature for the one record upon the match sub-table search locating no match signature in the match sub-table matching the match signature for the one record.

In another aspect of this disclosure, there is described a database cluster server that comprises a database, a match table, and a data clustering engine. The database comprises a plurality of records, with each said record comprising a plurality of fields. The match table comprises at least one previously-entered match signature, each being unique within the match table and being determined by an evaluation of a deterministic cluster definition against a respective record of the database. The deterministic cluster definition comprises a logical association of the fields and defines at least one data cluster. Each record of the database is associated with a respective one of the previously-entered match signatures via the deterministic cluster definition.

The data clustering engine is configured for communication with the database and the match table, and is configured to determine a match signature for a data record that is received at the data clustering engine by evaluating the deterministic cluster definition against the received data record. The data clustering engine is also configured to search the match table for a previously-entered match signature that matches the match signature that was determined for the received data record, and to update the match table with the match signature for the received data record upon the match table search locating no previously-entered match signature in the match table matching the match signature for the received data record.

In another aspect of this disclosure, there is described a computer-readable medium carrying computer processing instructions which, when executed by a computer, cause the computer to perform as follows:
determine a match signature for one record of a plurality of records, in which each record of the plurality of records comprising a plurality of fields, by evaluating against the one record a deterministic cluster definition that comprises a logical association of the fields and defines at least one data cluster of the plurality of the data records;
search a match table for a table entry matching the match signature, the match table comprising at least one previously-entered match signature, each previously-entered match signature being unique within the match table and being determined by evaluating the deterministic cluster definition against an other one of the records of the plurality of records, each said other record being associated with a respective one of the previously-entered match signatures via the deterministic cluster definition; and
determine the cluster of which the one record is a member by updating the match table with the match signature for the one record upon the match table search locating no previously-entered match signature in the match table matching the match signature for the one record.

In another aspect of this disclosure, there is described a method of managing a plurality of data records that involves determining a match signature for one record of the plurality of records by evaluating a deterministic cluster definition against the record. Each record of the plurality of records comprises a plurality of fields. The deterministic cluster definition comprises a logical association of the fields and defines at least one data cluster of the plurality of the data records.

A match table is searched for a table entry matching the match signature. The match table comprises at least one previously-entered match signature. Each previously-entered match signature is unique within the match table and is determined by evaluating the deterministic cluster definition against an other one of the records of the plurality of records. Each said other record is associated with a respective one of the previously-entered match signatures via the deterministic cluster definition.

The cluster of which the one record is a member is determined by updating the match table with the match signature for the one record upon the match table search locating no previously-entered match signature in the match table matching the match signature for the one record.

The logical association may comprise a logical AND association of at least two of the fields, a logical OR association of at least two of the fields, or both. The match signature determining may comprise, prior to the cluster definition evaluating, encoding character strings contained in the fields to reduce the edit distance between similar strings. A suitable form of character string encoding comprises phonetic match encoding.

In addition to the previously-entered match signatures, the match table may include plurality of previously-allocated cluster numbers, each being uniquely associated with a respective one of the previously-entered match signatures, and the method of managing a data records may also involve assigning (in response to a query that is associated with the deterministic cluster definition) either a new cluster number or a cluster number that was previously-allocated in the match table to the match signature for the one record, in accordance with the outcome of the search. The method may also involve replying to the query with the assigned cluster number.

In one implementation, the cluster comprises a hierarchical cluster, the match table comprises a plurality of match sub-tables, and at least one of the match sub-tables is associated with a respective logical AND association. Each of the match sub-tables is populated with at least one of the previously-entered match signatures. Each of the previously-entered match signatures may be determined from a respective logical AND association via the deterministic cluster definition, and is maintained in the match sub-table that is uniquely associated with the logical AND association.

In this implementation, the match signature for the one record may be determined by evaluating a respective logical AND association against the one record. The match table searching may comprise, for each determined match signature of the one record, searching the respective match sub-table for a sub-table entry matching the determined match signature. The deterministic cluster definition may be embedded within the query, or the query may include a reference to the deterministic cluster definition.

The assigned cluster number may be persistently assigned to the match signature for the one record (i.e. the assignment is maintained in the match table subsequent to the determination of the cluster of which the one record is a member).

The match table may be updated without sorting the plurality of data records. Further, the cluster definition may be evaluated without probabilistic matching. Therefore, the invention can realize performance improvements over the prior art.

### BRIEF DESCRIPTION OF THE DRAWINGS

FIG. 1 is a schematic view of the database cluster server, depicting the database management system and the clustering engine;

FIG. 2 is a flowchart depicting the operation of the database cluster server in which the deterministic cluster definition comprises a single cluster criterion, and the data records are ungrouped;

FIG. 3 is a flowchart depicting the operation of the database cluster server in which the edit distance between similar character strings in the data records has been reduced by the database management system prior to cluster identification by the clustering engine, and the deterministic cluster definition groups the data records; and

FIG. 4 is a flowchart depicting the operation of the database cluster server in which the clustering engine identifies clusters using multiple deterministic cluster definitions, and each cluster definition defines hierarchical clusters.

### DETAILED DESCRIPTION

Database Cluster Server 100

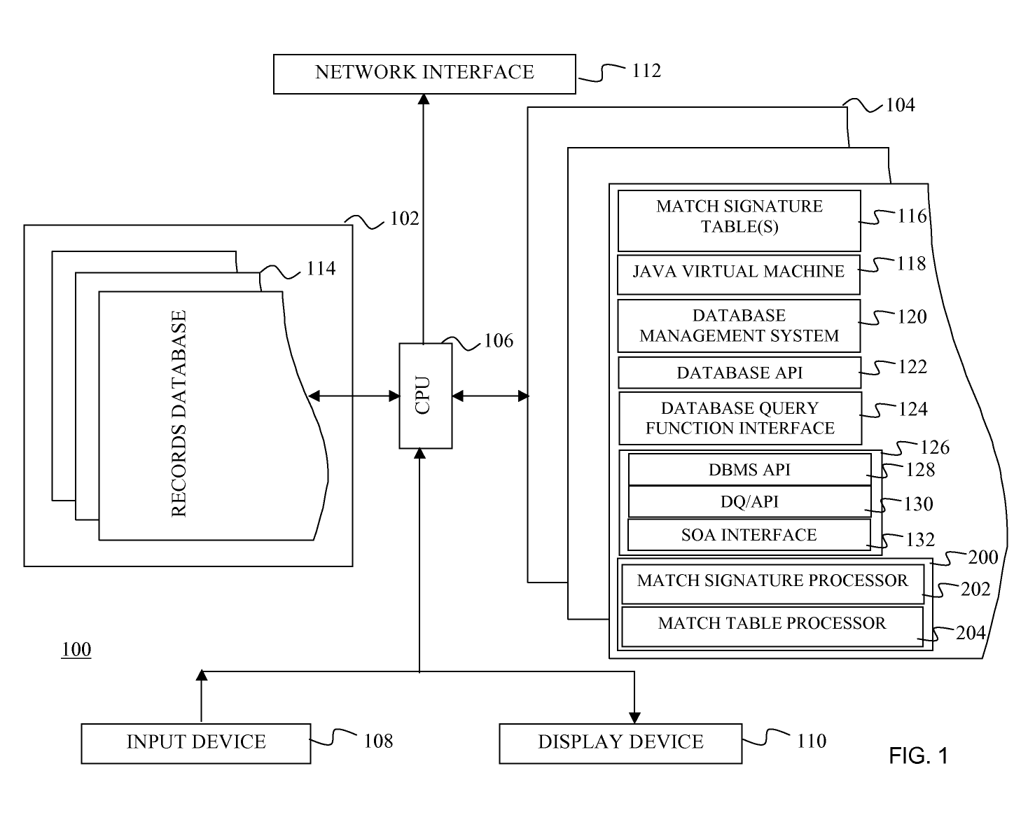

Turning to FIG. 1, a database cluster server 100 is implemented as a computer service, and comprises a non-volatile memory 102, a volatile memory (RAM) 104, and a central processing unit (CPU) 106 coupled to the non-volatile memory 102 and the RAM 104.

The database cluster server 100 may also include a data input device 108 (such as a keyboard), a display device 110 (such as a CRT or LCD panel), and a network interface 112 all coupled to the CPU 106. The data input device 108 allows the operator to input database query commands into the database cluster server 100. The display device 110 displays the responses generated by the database cluster server 100 in reply to the database query commands input by the operator. The network interface 112 allows the database cluster server 100 to be interfaced with the a communications network (not shown), and thereby communicate with remote clients and servers.

The non-volatile memory 102 database cluster server 100 may be provided as an electronic memory, a magnetic disc and/or an optical disc, and comprises a records database 114. The records database 114 comprises a plurality of data records, each comprising a plurality of fields. The records database 114 may be configured as a relational database, however the invention is not so limited. Further, although the records database 114, in the embodiment of FIG. 1, is maintained in the non-volatile memory 102 of the database cluster server 100, the records database 114 may also be maintained on a separate networked computer server which is accessible to the database cluster server 100 via the network interface 112.

In addition to the records database 114, the non-volatile memory 102 also includes computer processing instructions for the database cluster server 100 which, when loaded into the RAM 104 and executed by the CPU 106, implement an operating system and computer programs. The operating system controls the low level operating functions of the database cluster server 100, including processing data input from the data input device 108, generating output on the display device 110, and communicates with remote clients and servers via the network interface 112. In addition, the operating system may also include a Java Virtual Machine (JVM) 118 to allow the database cluster server 100 to interpret and execute Java bytecode.

The computer programs comprise a database management system (DBMS) 120, and a database application program interface (DB API) 122. The DBMS 120 is in communication with the records database 114, and controls the organization, storage and retrieval of data stored in the records database 114. As mentioned, the records database 114 may be configured as a relational database, in which case the DBMS 120 comprises a relational database management system. Further, preferably the DBMS 120 implements the foregoing functionality using Structured Query Language (SQL). The DB API 122 is an interface to the DBMS 120.

The computer programs may also comprise a database query function interface 124, a data cluster API 126, and a data clustering engine 200. Although the data cluster API 126 and the data clustering engine 200 are depicted in FIG. 1 as being deployed on the database cluster server 100 with the DBMS 120 and the DB API 122, the data cluster API 126 and the data clustering engine 200 may be deployed on a computer server that is separate from the DBMS 120 and the DB API 122.

The database query function interface 124 facilitates the identification of data clusters of the data records in the records database 114 by allowing the DBMS 120 to make SQL-based function calls (via the DB API 124) to the data clustering engine 200.

The data cluster API 126 is an interface to the data clustering engine 200. As mentioned, the data clustering engine 200 may be integrated with the DBMS 120 on the database cluster server 100. Therefore, the data cluster API 126 may comprise a DBMS API 128 that interfaces with the DB API 124 to thereby provide the database query function interface 124 with access to the data clustering engine 200.

However, since the data clustering engine 200 may also be deployed on a computer server that is separate from the DBMS 120, the data cluster API 126 may comprise a published data quality interface (DQ/API) 130, and a SOA Interface 132. Preferably, the DQ/API 130 is implemented in a programming language that is native to the data clustering engine 200, and provides external applications with access to the data clustering engine 200. The SOA Interface 132 is a web service interface to the data clustering engine 200.

In addition to the aforementioned computer processing instructions (when loaded into the RAM 104 from the non-volatile memory 102), the RAM 104 also includes one or more match signature tables 116 which the data clustering engine 200 uses to identify data clusters of the data records in the records database 114. Each match signature table 116 comprises a plurality of match signatures, with each data record of the records database 114 being associated with a respective match signature in the match signature table 116.

As will be explained, the data clustering engine 200 identifies the data clusters by evaluating a deterministic cluster definition against the data records of the records database 114. The deterministic cluster definition may be defined within a query to the DBMS 120, or may be maintained externally to the DBMS 120 and referenced by the query.

The deterministic cluster definition defines each data cluster as a logical association of the fields of the database records, and provides the same match signature for each data record that is a member of the data cluster. The logical association (as specified in the deterministic cluster definition) may comprise a logical OR association and/or a logical AND association of at least two of the fields of the data records in the record database 114. In this case, the match signature table 116 may comprise a plurality of match sub-tables, with at least one of the match sub-tables being associated with the fields of the logical OR association or the logical AND association.

The logical association (as specified in the deterministic cluster definition) may also comprise a plurality of logical AND associations of at least two of the fields of the data records in the record database 114, and a logical OR association of the logical AND associations. In this case, preferably the match signature table 116 comprises a plurality of match sub-tables, at least one of which is associated with the fields of one of the logical AND associations.

The data clustering engine 200 maintains the match signature table(s) 116 in the RAM 104 to enhance the speed of the cluster identification. Since the data clustering engine 200 and the DBMS 120 may be deployed on a common computer server, the match signature table(s) 116 may be maintained on the same computer server as the DBMS 120. However, the match signature table(s) 116 may also be deployed on a computer server that is separate from the DBMS 120.

Further, the data clustering engine 200 may also maintain a copy of the match signature table(s) 116 in the non-volatile memory 102, in addition to or instead of the RAM 104. As will be explained, the data clustering engine 200 may maintain a copy of the match signature table(s) 116 in the non-volatile memory 102 to facilitate the rapid identification of clusters in a subsequent session of the data clustering engine 200 after re-instantiation of a previous session of the data clustering engine 200.

Data Clustering Engine 200

The data clustering engine 200 is configured for communication with the records database 114 and the match signature table(s) 116, and comprises a match signature processor 202 and a match table processor 204 that is configured for communication with the match signature processor 202. As mentioned, preferably the data clustering engine 200 is implemented in computer software. More preferably, the data clustering engine 200 is implemented via Java programming language, and is executed on the JVM 118. However, the data clustering engine 200 is not so limited to any particular software platform, or even a computer software implementation. Therefore, the match signature processor 202 and/or the match table processor 204 may be implemented using programming languages other than Java, or even in electronics hardware, such as via an application-specific integrated circuit (ASIC), instead of computer software.

The operation of the data clustering engine 200 will be explained in further detail below. However, it is sufficient to point out at this point in the description that the match signature processor 202 is configured for communication with the DBMS 120 (via the DB API 124 and the DBMS API 128), and to determine a match signature for each data record of the records database 114. The match signature processor 202 is configured to determine the match signatures by evaluating a deterministic cluster definition against each data record. As discussed above, the deterministic cluster definition comprises a logical association of the fields of the data records, and defines at least one data cluster of the data records.

The match table processor 204 is configured for communication with the match signature table(s) 116, and identifies the data clusters amongst the data records from the match signatures determined by the match signature processor 202. To do so, the match table processor 204 is configured to populate the match signature table(s) 116 with the match signatures such that each match signature is unique within the respective match signature table 116, and such that each data record of the records database 114 is associated with a respective match signature in the match signature table(s) 116.

Operation of Database Cluster Server 100

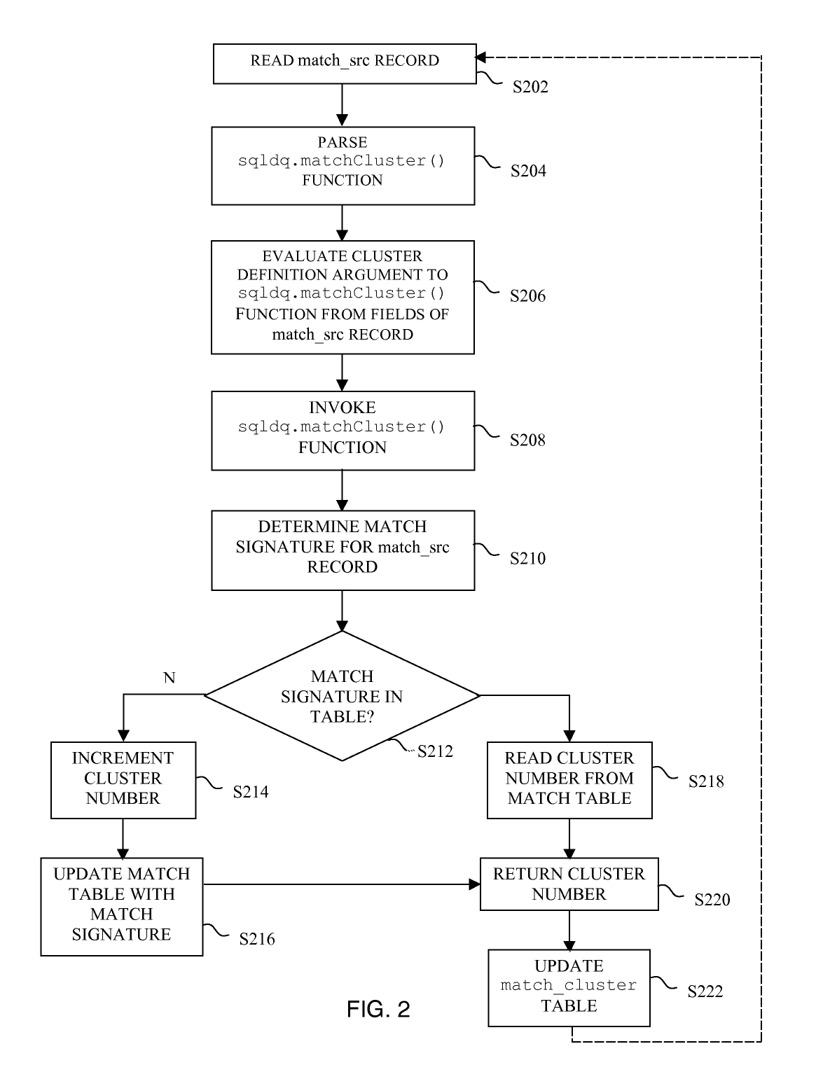

The method of operation of the database cluster server 100 will now be described with reference to the examples depicted in FIGS. 2 to 4.

### EXAMPLE 1

### Ungrouped Data; Single Cluster Criterion; Embedded Cluster Definition

In this first example, the records database 114 has the logical name “match_src”, and the data records thereof have the following data fields:
FNAME: first name
LNAME: surname
STRNO: street number
STRNAME: street name
PROVINCE: province

The deterministic cluster definition is embedded within a query to the DBMS 120. Also, the logical field association, specified in the deterministic cluster definition, defines a data cluster as a logical AND association of the FNAME, LNAME, STRNO, and STRNAME fields. In other words, a data record of the records database 114 will be a member of a data cluster if the character strings of the FNAME, LNAME, STRNO, and STRNAME fields of the data record respectively match the character strings of the FNAME, LNAME, STRNO, and STRNAME fields of all other data records in the data cluster.

The database cluster server 100 is configured to scan each data record of the records database 114, and to identify data clusters in these data records by populating a match signature table 116 with match signatures that are determined from an evaluation of the deterministic cluster definition. In this example, the database cluster server 100 identifies the data clusters by executing the following SQL query:

```
INSERT INTO match_cluster(
SELECT
  t1.FNAME,
  t1.LNAME,
  sqldq.matchCluster(
    “NOGROUP”,
    t1.FNAME || t1.LNAME || t1.STRNO || t1.STRNAME)
    as clstr_id
FROM match_src t1);
```

where:
match_cluster is the name of a table that identifies the cluster number for each match_src record; and
sqldq.matchCluster( ) is a Java function that returns cluster numbers (clstr_id) for each match_src record by evaluating the deterministic cluster definition against each match_src record.

The DBMS 120 maintains the match_cluster table either on the database cluster server 100 or on a computer server that is separate from the database cluster server 100.

The sqldq.matchCluster( ) function is implemented by the match signature processor 202 and the match table processor 204, and is callable by the database query function interface 124. The deterministic cluster definition is defined in this SQL query by the argument(s) to the sqldq.matchCluster( ) function (i.e. “NOGROUP”, t1.FNAME ∥ t1.LNAME ∥ t1.STRNO ∥ t1.STRNAME).

Referring to FIG. 2, the SELECT-FROM statement of the SQL query causes the DBMS 120 to read the FNAME field and the LNAME field from a first of the match_src records, at step S202.

At step S204, the SELECT-FROM statement causes the DBMS 120 to parse the sqldq.matchCluster( ) function. As mentioned, the deterministic cluster definition is defined in the SQL query by the argument(s) to the sqldq.matchCluster( ) function, and defines the data clusters of the match_src records. In this example, the first argument (“NOGROUP”) of the sqldq.matchCluster( ) function is predefined. However, at step S204, the value of the second argument (t1.FNAME ∥ t1.LNAME ∥ t1.STRNO ∥ t1.STRNAME) of the sqldq.matchCluster( ) function is undefined. Therefore, at step S206, the DBMS 120 evaluates this second argument against the current match_src record.

The second argument of the sqldq.matchCluster( ) function requires an evaluation of the logical AND association of the FNAME, LNAME, STRNO, and STRNAME fields of the current match_src record. In other words, the current match_src record will be a member of a data cluster (based on this deterministic cluster definition in this example) if the following cluster condition is met:
the character string of the FNAME field of the current match_src record matches the character string of the FNAME field of all other data records in the data cluster; AND
the character string of the LNAME field of the current match_src record matches the character string of the LNAME field of all other data records in the data cluster; AND
the character string of the STRNO field of the current match_src record matches the character string of the STRNO field of all other data records in the data cluster; AND
the character string of the STRNAME field of the current match_src record matches the character string of the STRNAME field of all other data records in the data cluster.

A character string that comprises the concatenation of the character strings of the FNAME, LNAME, STRNO and STRNAME fields of a match_src record can provide an indication of whether a match_src record satisfies these requirements. Therefore, at step S206, the DBMS 120 evaluates the second argument of the sqldq.matchCluster( ) function for the current match_src record by concatenating the character strings of the FNAME, LNAME, STRNO and STRNAME fields of the current match_src record.

At step S208, the DBMS 120 invokes the sqldq.matchCluster( ) function call, which causes the database query function interface 124 to pass the character strings of the evaluated arguments of the sqldq.matchCluster( ) function to the data cluster engine 200 as part of the sqldq.matchCluster( ) function call. In this example, the parameters passed to the sqldq.matchCluster( ) function comprise (1) a “NOGROUP” character string; and (2) a character string that consists of the concatenation of the character strings of the FNAME, LNAME, STRNO and STRNAME fields of the current match_src record.

At step S210, the match signature processor 202 determines a match signature for the current match_src record from the evaluated arguments of the sqldq.matchCluster( ) function for the current match_src record. The match signature processor 202 is configured such that all match_src records having the same match signature are members of the same data cluster, as defined by the deterministic cluster definition. Conversely, match_src records having different match signatures are members of different data clusters.

The first argument (“NOGROUP”) of the sqldq.matchCluster( ) function indicates that to the sqldq.matchCluster( ) function that the match_src records are not pre-grouped (e.g. by the character string in the PROVINCE field) prior to being processed by the sqldq.matchCluster( ) function. As will be explained in the second example, pre-grouping of the match_src records can increase the accuracy of the identification of related data records.

The second argument (t1.FNAME ∥ t1.LNAME ∥ t1.STRNO ∥ t1.STRNAME) of the sqldq.matchCluster( ) function is evaluated as a character string that consists of the concatenation of the character strings of the FNAME, LNAME, STRNO and STRNAME fields of the current match_src record. Since this second evaluated argument is consistent with the logical field association requirements of the deterministic cluster definition, at step S210 the match signature processor 202 can use this concatenated character string as the match signature of the current match_src record.

As will be explained, the match table processor 204 saves the match signatures for the match_src records in the match table 116. However, since the match table 116 may be maintained on a computer server that is separate from the DBMS 120, confidential information from the records database 114 might inadvertently become publicly available unless the computer server that maintains the match table 116 is secure. Alternately, to reduce the likelihood of inadvertent disclosure of confidential information, at step S210 the match signature processor 202 may determine the match signature for the current match_src record by encrypting the second evaluated argument of the sqldq.matchCluster( ) function for the current match_src record. Preferably, the match signature processor 202 determines the match signature for the current match_src record, at step S310, by applying a one-way hash algorithm to the second evaluated argument of the sqldq.matchCluster( ) function for the current match_src record.

The match table processor 204 is configured to populate the match signature table 116 with match signatures such that each match signature is unique within the match signature table 116. Therefore, at step S212, the match table processor 204 queries the match signature table 116 with the match signature for the current match_src record (determined by the match signature processor 202) to determine whether the match signature for the current match_src record matches any of the match signatures previously saved in the match signature table 116.

Preferably, the match table processor 204 also maintains a cluster count value indicative of the number of entries in the match signature table 116. If the query of the match signature table 116 reveals that the match signature has not been previously saved in the match signature table 116, the match table processor 204 increments the cluster count value, at step S214, and then updates the match signature table 116 with the incremented cluster count value and the match signature for the current match_src record, at step S216. At step S220, the match table processor 204 returns the incremented cluster count value to the RDMS 120 as the clstr_id parameter of the sqldq.matchCluster( ) function.

Alternately, if the query of the match signature table 116 reveals that the match signature has already been saved in the match signature table 116, at step S218 the match table processor 204 retrieves from the match signature table 116 the cluster count value that was saved with the match signature in the match signature table 116. At step S220, the match table processor 204 returns the retrieved cluster count value to the RDMS 120 as the clstr_id parameter of the sqldq.matchCluster( ) function.

Since the cluster count value is only incremented when the match signature table 116 is updated with a new match signature, the returned clstr_id value will be uniquely associated with a respective one of the match signatures entered in the match signature table 116. Further, since a match signature is only added to the match signature table 116 when the query of the match signature table 116 reveals that the match signature has not already been saved in the match signature table 116, each data record of the records database 114 will be associated with only one of the match signatures in the match signature table 116.

The INSERT INTO statement of the SQL query causes the DBMS 120 to add to the match_cluster table a new record, at step S222, that includes the character string of the FNAME field, the LNAME field, and the cluster number (clstr_id) for the current match_src record.

The DBMS 120 repeats steps S202 to S222 until all the data records of the records database 114 have been processed. Since each match signature is unique within the match signature table 116, after all of the data records of the records database 114 are processed each data record will be associated with only one of the match signatures in the match signature table 116. Further, the match_cluster table will identify the number (clstr_id) of the cluster of which each data record is a member. Therefore, tuples of the data records can be quickly identified by simply sorting the match_cluster table according to clstr_id.

Although the foregoing cluster identification is performed against all of the records of the records database 114 (i.e. in batch mode), the database cluster server 100 may also be configured to process new data records, in real time, as they are prepared to be entered into the records database 114. In this variation, the data clustering engine 200 would receive each new data record from the DBMS 120, and would return a cluster count value to the RDMS 120 in real time, after performing steps S202 to S220 using the received data record as the current match_src record.

Further, as mentioned, although the data clustering engine 200 typically maintains the match signature table 116 in the RAM 104, the data clustering engine 200 may save a persistent copy of the match signature table 116 in the non-volatile memory 102 after each data record is processed (e.g. at step S220). With this variation, each cluster count value will be persistently assigned to the associated match signature after the cluster number for the data record has been determined. If the current instance of the data cluster engine 200 is terminated and the subsequently re-instantiated, the data clustering engine 200 will be able to re-instantiate the match signature 116 in the RAM 104 from the copy of same in the non-volatile memory 102. As a result, the data clustering engine 200 will be able to process each new data record as it is received from the DBMS 120, without having to first re-populate the entire match signature table 116 with the match signatures for the data records already saved in the records database 114.

### EXAMPLE 2

### Grouped Data; Match Codes; Single Cluster Criterion; Embedded Cluster Definition

In this second example, the records database 114 has the logical name “match_src”, and the data records thereof have the following data fields:
FNAME: first name
LNAME: surname
STRNO: street number
STRNAME: street name
PROVINCE: province
FNAME_mtchcd: encoded first name data
LNAME_mtchcd: encoded surname data
STRNAME_mtchcd: encoded street name data

The deterministic cluster definition is embedded within a query to the DBMS 120. The logical field association, specified in the deterministic cluster definition, defines a data cluster as a logical AND association of the FNAME_mtchcd, LNAME_mtchcd, STRNO, and STRNAME_mtchcd fields. In other words, a data record of the records database 114 will be a member of a data cluster if the character strings of the FNAME_mtchcd, LNAME_mtchd, STRNO, and STRNAME_mtchcd fields of the data record respectively match the character strings of the FNAME_mtchcd, LNAME_mtchcd, STRNO, and STRNAME_mtchcd fields of all other data records in the data cluster.

Again, the database cluster server 100 is configured to scan each data record of the records database 114, and to identify data clusters in these data records by populating match signature tables 116 with match signatures that are determined from an evaluation of the deterministic cluster definition. In this example, the database cluster server 100 identifies the data clusters by executing the following SQL query:

```
INSERT INTO match_cluster(
SELECT
  t1.FNAME,
  t1.LNAME,
  t1.STRNO,
  t1.STRNAME,
  sqldq.matchCluster(
      t1.PROVINCE,
      t1.FNAME_mtchcd || t1.LNAME_mtchcd || t1.STRNO ||
      t1.STRNAME_mtchcd) as clstr_id
FROM match_src t1);
```

As above, the sqldq.matchCluster( ) function is implemented by the match signature processor 202 and the match table processor 204, and is callable by the database query function interface 124. The deterministic cluster definition is defined in this SQL query by the argument(s) to the sqldq.matchCluster( ) function (i.e. t1.PROVINCE, t1.FNAME_mtchcd ∥ t1.LNAME_mtchcd ∥ t1.STRNO ∥ t1.STRNAME_mtchcd).

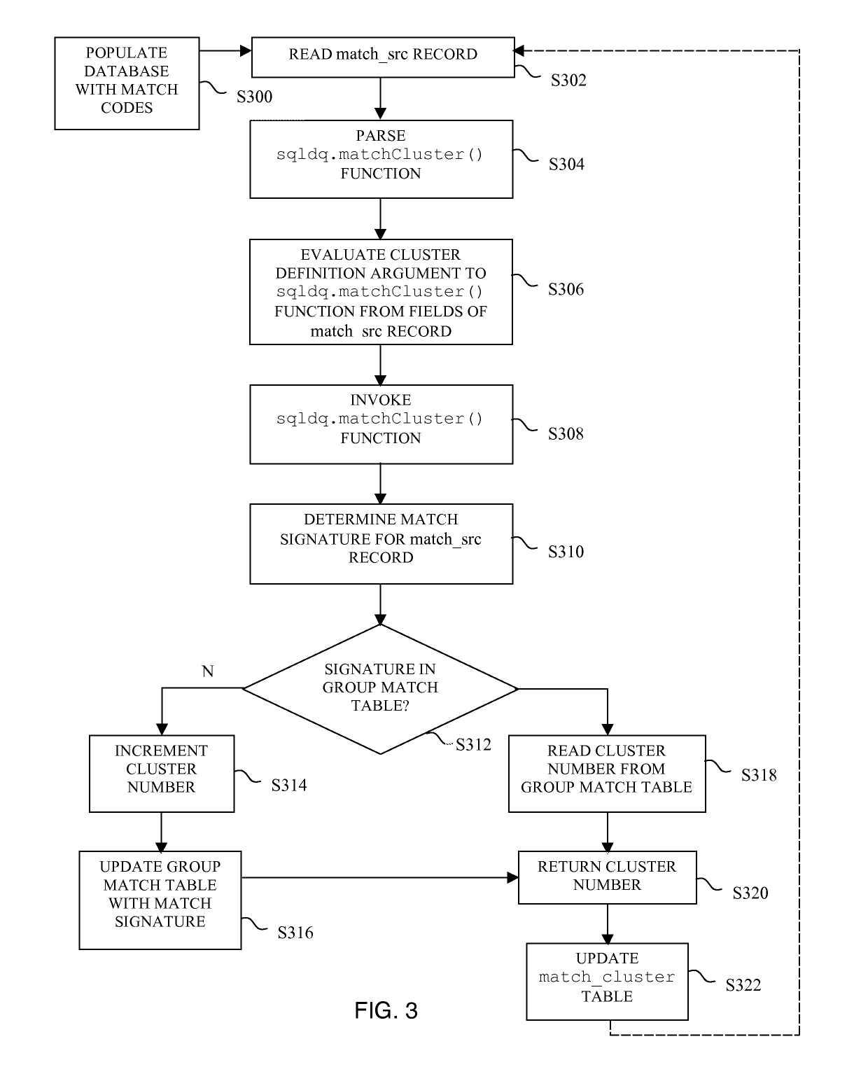

Referring now to FIG. 3, prior to invocation of the SQL query, the database query function interface 124 populates the FNAME_mtchcd, LNAME_mtchcd, and STRNAME_mtchcd fields of each data record of the records database 124 with match codes that are derived respectively from the character strings of the FNAME, LNAME, and STRNAME fields. As will be explained, the data cluster engine 200 uses the match codes in the FNAME_mtchcd, LNAME_mtchcd, and STRNAME_mtchcd fields as a means to increase the speed and accuracy of the cluster identification for the match_src records.

By way of explanation, recall that in the first example the data cluster engine 200 determined the match signatures for the data records of the records database 114 from a concatenation of the character strings of the FNAME, LNAME, STRNO and STRNAME fields of each record. The data cluster engine 200 determined that a data record was a member of a data cluster if the match signature for the data record was an exact match of the match signatures for all other data records of the data cluster. With this approach, if the character strings of the data records are input manually, data entry errors in the creation of the data records might cause the data cluster engine 200 to assign to different data clusters data records that actually represent the same information, but appear to be different due to the data entry error. For instance, in the first example, the records database 114 might have included the following two data records:

| Record #1: | Record #2: |
|---|---|
| FNAME: John | FNAME: John |
| LNAME: Smith | LNAME: Smth |
| STRNO: 100 | STRNO: 100 |
| STRNAME: Main Street | STRNAME: Main Street |
| PROVINCE: Ontario | PROVINCE: Ontario |

In the first example, the data cluster engine 200 would assign these two data records to different clusters, even though the two data records are identical, apart from the typographical error in the LNAME field of the second data record. The use of match codes in this second example provides a solution to this problem.

Therefore, at step S300, the database query function interface 124 populates the FNAME_mtchcd, LNAME_mtchcd, and STRNAME_mtchcd fields of each data record with match codes that are derived respectively from the character strings of the FNAME, LNAME, and STRNAME fields of the respective data record, but which reduce the edit distance between similar character strings.

For example, referring to the preceding table, the character string “Smth” can be transformed into the character string “Smith” with a single character (insertion) operation. Therefore, the character string of the LNAME_mtchcd: field may be derived from the LNAME field such that the character string “Smith” and the character string “Smth” have the same match code (i.e. the edit distance=0). The database query function interface 124 can reduce the edit distance between similar character strings by phonetic match encoding of the character strings, such as via Soundex phonetic encoding, New York State Identification and Intelligence System (NYSIIS) phonetic encoding, and Metaphone/Double-Metaphone phonetic encoding.

If all of the match codes are determined, for example, using phonetic matching, data records will be considered to be members of the same data cluster if the match codes for the data records are a phonetic match (viz FNAME, LNAME, and STRNAME). However, a combination of exact and phonetic matching can be employed. Therefore, the logical field association, specified in the deterministic cluster definition, could, for example, define a data cluster as a logical AND association of the FNAME_mtchcd, LNAME_mtchcd, STRNO, and STRNAME fields, in which case data records would be considered to be members of the same data cluster if the data records were an exact match viz the STRNO, and STRNAME fields, and a phonetic match viz the FNAME_mtchcd and LNAME_mtchcd fields.

Further, as discussed above, the data clustering engine 200 may be deployed on a computer server that is separate from the DBMS 120. Therefore, to prevent inadvertent public disclosure of confidential information, at step S300 the database query function interface 124 may populate the FNAME_mtchcd, LNAME_mtchcd, and STRNAME_mtchcd fields by encrypting the phonetically (or exact/phonetically) encoded FNAME, LNAME, and STRNAME fields, and then saving the respective encrypted match codes in the FNAME_mtchcd, LNAME_mtchcd, and STRNAME_mtchcd fields. Preferably, the database query function interface 124 encrypts the phonetic (or exact/phonetic) codes, at step S300, by applying a one-way hash algorithm to the phonetic (or exact/phonetic) codes for each match_src record.

However, phonetic match encoding using Soundex or Metaphone/Double-Metaphone phonetic encoding may realize less than optimal results. The Soundex algorithm was developed for encoding English words. The Lawrence Phillips Metaphone algorithm and the Double Metaphone algorithm are both useful for encoding English words, with the Double Metaphone algorithm including support for some Slavo-Germanic words. Consequently, non-English names might not correctly encode using these algorithms.

To address this deficiency, the match codes for the FNAME and/or LNAME and/or STRNAME fields may be determined using fuzzy standardization, and phonetic normalization. Fuzzy standardization allows the data clustering engine 200 to standardize words by reducing the impact typographical errors may have in the determination of the match code.

To implement fuzzy standardization, the data clustering engine 200 may be provided with one or more dictionaries, each populated with a plurality of reference names. Preferably, the dictionaries are populated with first/given names and/or surnames and/or street names.

The data clustering engine 200 effects fuzzy standardization of a match_src record by performing a lookup to the dictionaries for each data record, using the character string of the FNAME and/or LNAME and/or STRNAME fields of the data record. If the character string of the data record is an exact match to one of the reference names in the dictionaries, the data clustering engine 200 uses the character string for the determination of the match code. As discussed above, preferably the database query function interface 124 determines the match code by applying a one-way hash algorithm to the character string.

However, if the character string of the data record is not an exact match to one of the reference names, the data clustering engine 200 uses a distance algorithm to calculate the edit distance between the character string and a plurality of the reference names in the dictionaries. The data clustering engine 200 then selects the reference name whose edit distance indicates that the degree of correspondence between the reference name and the character string (confidence value) exceeds a threshold value. The data clustering engine 200 uses the selected reference name for the determination of the match code.

If the confidence value for more than one reference name exceeds the threshold value (candidate reference names), the data clustering engine 200 selects from the candidate reference names the reference name that has the largest confidence value. The data clustering engine 200 uses the reference name with the largest confidence value for the determination of the match code.

If multiple candidate reference names all have the same confidence value, the data clustering engine 200 may use phonetic normalization to determine the match code for the match_src record. Phonetic normalization allows the data clustering engine 200 to evaluate the phonetic similarity between the character strings of a match_src record and the candidate reference names.

To implement phonetic normalization, the data clustering engine 200 is configured with one or more phonetic maps, each associated with a specific language (e.g. English, German, French). Each phonetic map associates a character, or sequence of characters, with its phonetic equivalent(s) for the associated language. For example, one phonetic map may include the following character-phonetic associations:
AE→E
CY→S
SCH→SK or SH
CZ→x
WICZ→TS

The data clustering engine 200 effects phonetic normalization by transforming the character string of the match_src record to its meta-language equivalent using the phonetic map for the language associated with the match_src record. The data clustering engine 200 also transforms each of the candidate reference names that have the same confidence value to their respective meta-language equivalents using the phonetic maps.

The data clustering engine 200 selects from the candidate reference names the reference name whose meta-language equivalent matches the meta-language equivalent of the character string of the match_src record. The data clustering engine 200 then uses the reference name with the matching meta-language equivalent for the determination of the match code. As discussed above, preferably the database query function interface 124 determines the match code by applying a one-way hash algorithm to the reference name.

After the records database 114 is populated with the (encrypted) match codes, the SELECT-FROM statement of the SQL query causes the DBMS 120 to read the FNAME field, the LNAME field, the STRNO field, and the STRNAME field from a first of the match_src records, at step S302.

At step S304, the SELECT-FROM statement causes the DBMS 120 to parse the sqldq.matchCluster( ) function. In this example, at step S304 the value of the first argument (t1.PROVINCE) of the sqldq.matchCluster( ) function is defined. However, at step S304, the value of the second argument (t1.FNAME_mtchcd ∥ t1.LNAME_mtchcd ∥ t1.STRNO ∥ t1.STRNAME_mtchcd) of the sqldq.matchCluster( ) function is undefined. Therefore, at step S306, the DBMS 120 evaluates the second argument of the sqldq.matchCluster( ) function against the current match_src record.

The second argument of the sqldq.matchCluster( ) function requires an evaluation of the logical AND association of the FNAME_mtchcd, LNAME_mtchcd, STRNO, and STRNAME_mtchcd fields of the current match_src record. In other words, the current match_src record will be a member of a data cluster (based on this deterministic cluster definition in this example) if the following cluster condition is met:
the character string of the FNAME_mtchcd field of the current match_src record matches the character string of the FNAME_mtchcd field of all other data records in the data cluster; AND
the character string of the LNAME_mtchcd field of the current match_src record matches the character string of the LNAME_mtchcd field of all other data records in the data cluster; AND
the character string of the STRNO field of the current match_src record matches the character string of the STRNO field of all other data records in the data cluster; AND
the character string of the STRNAME_mtchcd field of the current match_src record matches the character string of the STRNAME_mtchcd field of all other data records in the data cluster.

A character string that comprises the concatenation of the character strings of the FNAME_mtchcd, LNAME_mtchcd, STRNO and STRNAME_mtchcd fields of a match_src record can provide an indication of whether a match_src record satisfies these requirements. Therefore, at step S306, the DBMS 120 evaluates the second argument of the sqldq.matchCluster( ) function for the current match_src record by concatenating the character strings of the FNAME_mtchcd, LNAME_mtchcd, STRNO and STRNAME_mtchcd fields of the current match_src record.

At step S308, the DBMS 120 invokes the sqldq.matchCluster( ) function call, which causes the database query function interface 124 to pass the character strings of the evaluated arguments of the sqldq.matchCluster( ) function to the data cluster engine 200 as part of the sqldq.matchCluster( ) function call. In this example, the parameters passed to the sqldq.matchCluster( ) function comprise (1) a character string that consists of the PROVINCE field of the current match_src record, and (2) a character string that consists of the concatenation of the character strings of the FNAME_mtchcd, LNAME_mtchcd, STRNO and STRNAME_mtchcd fields of the current match_src record.

At step S310, the match signature processor 202 determines a match signature for the current match_src record from the evaluated arguments of the sqldq.matchCluster( ) function for the current match_src record. Since, in this second example, the second evaluated argument that is passed to the sqldq.matchCluster( ) function is consistent with the logical field requirements of the deterministic cluster definition, at step S310 the match signature processor 202 can use the concatenation of the character strings of the FNAME_mtchcd, LNAME_mtchcd, STRNO and STRNAME_mtchcd fields of the current match_src record as the match signature of the current match_src record.

Although, as discussed above, the FNAME_mtchcd, LNAME_mtchcd, and STRNAME_mtchcd fields may be encrypted (and therefore not reveal any confidential information regarding the character strings in the FNAME, LNAME, and STRNAME fields, the match signature processor 202 may determine the match signature for the current match_src record, at step S310, by applying a one-way hash algorithm to the second evaluated argument of the sqldq.matchCluster( ) function for the current match_src record.

In this example, the match table processor 204 maintains the match signatures for the data records in a plurality of the match signature tables 116, with each match signature table 116 being associated with a respective PROVINCE field character string. To facilitate this result, the match table processor 204 is configured to save the match signatures in the match signature tables 116 based on the first argument of the sqldq.matchCluster( ) function. In this case, the first argument causes the match table processor 204 to group the match signatures within the match signature tables 116 based on the character string in the PROVINCE field. Therefore, in contrast to the first example, the match table processor 204 doesn't save each match signature within the same match signature table 116. Instead, the match table processor 204 saves in one match signature table 116 all of the match signatures whose associated PROVINCE field character string matches, for example, the character string “Ontario”; and saves in another match signature table 116 all match signatures whose associated PROVINCE field character string matches, for example, the character string “Quebec”. Although, in this example, the match table processor 204 groups the data records by the PROVINCE field character string, the match table processor 204 can group the data records using other data fields as the group key.

Recall that, in the first example, the match_src records were not grouped. By grouping match signatures according to a common characteristic (such as the character string in the PROVINCE field, for example), the accuracy in the identification of related data records will be reduced since multiple data records whose FNAME field and LNAME field strings were the same, but whose PROVINCE field strings were different, might actually be associated with the same person. However, grouping of match signatures allows the size of the match signature tables 116 to be controlled more easily and, therefore, the speed in the identification of related records to be enhanced.

The match table processor 204 is also configured to populate the match signature tables 116 with match signatures such that each match signature is unique within the respective match signature table 116. Therefore, at step S312, the match table processor 204 queries the match signature table 116 (that is associated with the respective associated PROVINCE field character string) with the match signature for the current match_src record to determine whether the match signature for the current match_src record matches any of the match signatures previously saved in the respective match signature table 116. Since each match signature table 116 is associated with a respective PROVINCE field character string, the number of entries in each match signature table 116 may be less than the first example. Therefore, grouping of the match signatures can also increase the speed of the match table query. Further, if the match signature processor 202 determine the match signature for the current match_src record, at step S310, by applying a one-way hash algorithm to the second evaluated argument of the sqldq.matchCluster( ) function, the match table processor 204 may be able to make use of standard hash-table lookup algorithms to further increase the speed of the match table query.

Preferably, the match table processor 204 also maintains a cluster count value indicative of the number of entries in all of the match signature tables 116. If the query of the respective match signature table 116 reveals that the match signature has not been previously saved in the match signature table 116, the match table processor 204 increments the cluster count value, at step S314, and then updates the respective match signature table 116 with the incremented cluster count value and the match signature for the current match_src record, at step S316. At step S320, the match table processor 204 returns the incremented cluster count value to the RDMS 120 as the clstr_id parameter of the sqldq.matchCluster( ) function.

Alternately, if the query of the match signature table 116 reveals that the match signature has already been saved in the respective match signature table 116, at step S318 the match table processor 204 retrieves from the match signature table 116 the cluster count value that was saved with the match signature in the match signature table 116. At step S320, the match table processor 204 returns the retrieved cluster count value to the RDMS 120 as the clstr_id parameter of the sqldq.matchCluster( ) function.

Since the cluster count value is only incremented when one of the match signature tables 116 is updated with a new match signature, the returned clstr_id value will be uniquely associated with a respective one of the match signatures entered in the match signature tables 116. Further, since a match signature is only added to the match signature tables 116 when the query of the respective match signature table 116 reveals that the match signature has not already been saved in the match signature table 116, each data record of the records database 114 will be associated with only one of the match signatures in the match signature tables 116.

The INSERT INTO statement of the SQL query causes the DBMS 120 to add to the match_cluster table a new record, at step S322, that includes the character string of the FNAME field, the LNAME field, the STRNO field, the STRNAME field, and the cluster number (clstr_id) for the current match_src record.

The DBMS 120 repeats steps S302 to S322 until all the data records of the records database 114 have been processed. Since each match signature is unique within the respective match signature table 116, after all of the data records of the records database 114 are processed each data record will be associated with only one of the match signatures in its match signature table 116. Further, the match_cluster table will identify the number (clstr_id) of the cluster of which each data record is a member. Therefore, tuples of the data records can be quickly identified by simply sorting the respective match_cluster table according to clstr_id.

### EXAMPLE 3

### Multiple Cluster Definitions; Hierarchical Clusters; Embedded Cluster Definitions

In this third example, the records database 114 has the logical name “match_src”, and the data records thereof have the following data fields:
FNAME: first name
LNAME: surname
STRNO: street number
STRNAME: street name
PROVINCE: province
TEL_ADR: telephone number
FNAME_mtchcd: encoded first name data
LNAME_mtchcd: encoded surname data
STRNAME_mtchcd: encoded street name data

In this example, two logical field associations are specified in two deterministic cluster definitions. Each deterministic cluster definition is embedded within a common query to the DBMS 120. Both deterministic cluster definitions are evaluated as each match_src is read from the records database 114, thereby reducing the number of database queries required to populate the match signature tables 116.

The cluster of each deterministic cluster definitions comprises a hierarchical cluster, in the sense that each hierarchical cluster comprises a plurality of sub-clusters. In this third example, the logical field association, specified in the each deterministic cluster definition, comprises a logical OR association of two logical AND associations. However, other logical field associations are possible. For instance, the logical field association may comprise a logical OR association of a plurality of logical AND and/or OR associations. The logic field association may comprise a logical AND association of a plurality of logical AND and/or OR associations.

In the logical field association specified in the first deterministic cluster definition, the data cluster is defined as a logical OR association of (1) a logical AND association of the FNAME_mtchcd, LNAME_mtchcd, STRNO, and STRNAME_mtchcd fields; and (2) a logical AND association of the FNAME_mtchcd, LNAME_mtchcd, and TEL_ADR fields. Therefore, the first deterministic cluster definition defines a hierarchical cluster that comprises two sub-clusters. A data record of the records database 114 will be a member of the first sub-cluster of the hierarchical cluster of the first deterministic cluster definition if the character strings of the FNAME_mtchcd, LNAME_mtchd, STRNO, and STRNAME_mtchcd fields of the data record respectively match the character strings of the FNAME_mtchcd, LNAME_mtchcd, STRNO, and STRNAME_mtchcd fields of all other data records in the data cluster. A data record of the records database 114 will be a member of the second sub-cluster of the hierarchical cluster of the first deterministic cluster definition if the character strings of the FNAME_mtchcd, LNAME_mtchd, and TEL_ADR fields of the data record respectively match the character strings of the FNAME_mtchcd, LNAME_mtchd, and TEL_ADR fields of all other data records in the data cluster. As a result, a data record will be a member of the hierarchical data cluster of the first deterministic cluster definition if the data record is a member of either of the two sub-clusters of the hierarchical cluster.

In the logical field association, specified in the second deterministic cluster definition, the data cluster is defined as a logical OR association of (1) a logical AND association of the LNAME_mtchcd, STRNO, and STRNAME_mtchcd fields; and (2) a logical AND association of the LNAME_mtchcd, and TEL_ADR fields. Therefore, the second deterministic cluster definition also defines a hierarchical cluster that comprises two sub-clusters. A data record of the records database 114 will be a member of the first sub-cluster of the hierarchical cluster of the second deterministic cluster definition if the character strings of the LNAME_mtchd, STRNO, and STRNAME_mtchcd fields of the data record respectively match the character strings of the LNAME_mtchcd, STRNO, and STRNAME_mtchcd fields of all other data records in the data cluster. A data record of the records database 114 will be a member of the second sub-cluster of the hierarchical cluster of the second deterministic cluster definition if the character strings of the LNAME_mtchd, and TEL_ADR fields of the data record respectively match the character strings of the LNAME_mtchd, and TEL_ADR fields of all other data records in the data cluster. As a result, a data record will be a member of the hierarchical data cluster of the second deterministic cluster definition if the data record is a member of either of the two sub-clusters of the hierarchical cluster.

Again, the database cluster server 100 is configured to scan each data record of the records database 114, and to identify data clusters in these data records by populating match signature tables 116 with match signatures that are determined from an evaluation of the deterministic cluster definition. In this third example, the database cluster server 100 identifies the data clusters by executing the following SQL query:

```
INSERT INTO match_cluster(
SELECT
  t2.FNAME,
  t2.LNAME,
  t2.STRNO,
  t2.STRNAME,
  t2.TEL_ADR,
  sqldq.matchCluster(
      t2.PROVINCE,
      t2.FNAME_mtchcd || t2.LNAME_mtchcd || t2.STRNO ||
      t2.STRNAME_mtchcd,
      t2.FNAME_mtchcd || t2.LNAME_mtchcd || t2.TEL_ADR)
      as clstr_Id_1
  sqldq.matchCluster(
      t2.PROVINCE,
      t2.LNAME_mtchcd || t2.STRNO || t2.STRNAME_mtchcd,
      t2.LNAME_mtchcd || t2.TEL_ADR) as clstr_id_2
FROM (
        SELECT
          t1.FNAME,
          t1.LNAME,
          t1.TEL_ADR,
          t1.PROVINCE,
          t1.FNAME_mtchcd,
          t1.LNAME_mtchcd,
          t1.STRNO,
          t1.STRNAME_mtchcd
        FROM match_src t1
        ORDER BY t1.PROVINCE
      ) t2;
```

The first deterministic cluster definition is defined in this SQL query by the argument(s) to the first sqldq.matchCluster( ) function instance (i.e. t2.PROVINCE, t2.FNAME_mtchcd ∥ t2.LNAME_mtchcd ∥ t2.STRNO ∥ t2.STRNAME_mtchcd, t2.FNAME_mtchcd ∥ t2.LNAME_mtchcd ∥ t2.TEL_ADR). Similarly, the second deterministic cluster definition is defined in this SQL query by the argument(s) to the second sqldq.matchCluster( ) function instance (i.e. t2.PROVINCE, t2.LNAME_mtchcd ∥ t2.STRNO ∥ t2.STRNAME_mtchcd, t2.LNAME_mtchcd ∥ t2.TEL_ADR).

Both instances of the sqldq.matchCluster( ) function are implemented by the match signature processor 202 and the match table processor 204, and are callable by the database query function interface 124. Although, in this example, the SQL query includes two distinct deterministic cluster definitions, additional deterministic cluster definitions can be evaluated by adding sqldq.matchCluster( ) function instances to the SQL query.

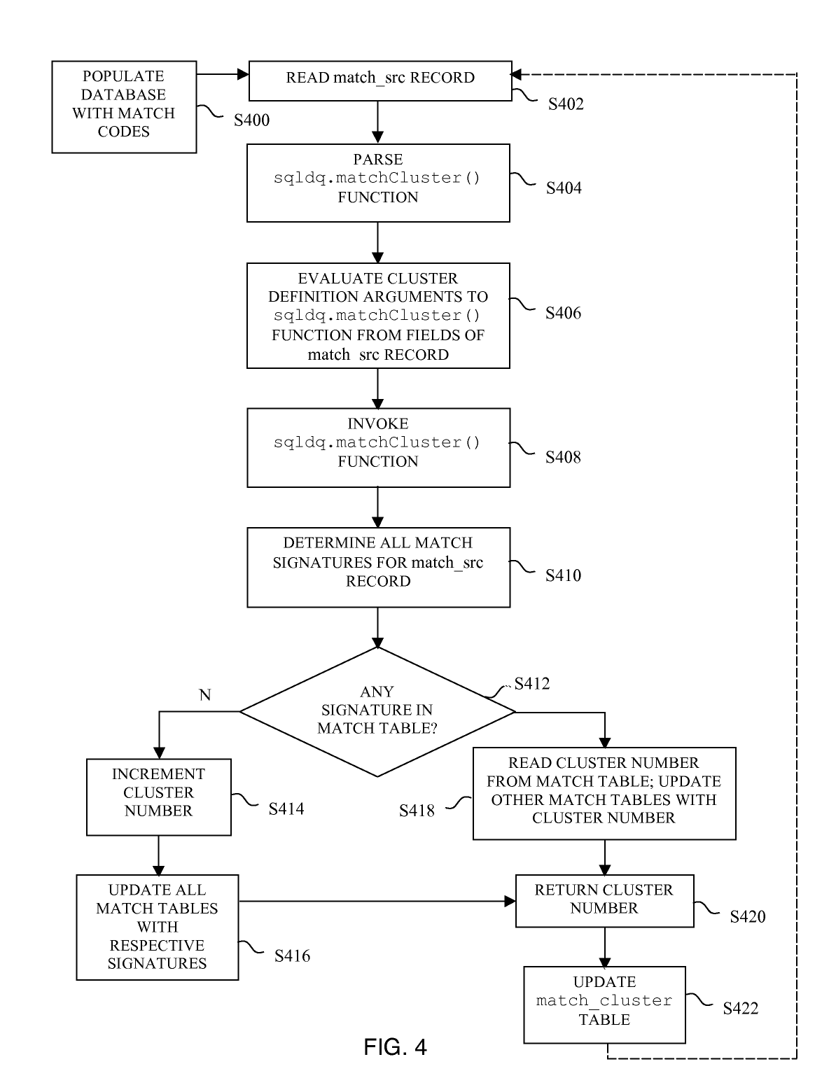

Referring now to FIG. 4, at step S400 the database query function interface 124 populates the FNAME_mtchcd, LNAME_mtchcd, and STRNAME_mtchcd fields of each data record of the records database 124 with match codes that are derived respectively from the character strings of the FNAME, LNAME, and STRNAME fields, but which reduce the edit distance between similar character strings. The database query function interface 124 can reduce the edit distance between similar character strings by phonetic match encoding of the character strings.

As in the second example, a combination of exact and phonetic matching can also be employed. Further, the database query function interface 124 may populate the FNAME_mtchcd, LNAME_mtchcd, and STRNAME_mtchcd fields by encrypting the phonetically (or exact/phonetically) encoded FNAME, LNAME, and STRNAME fields, and then saving the respective encrypted match codes in the FNAME_mtchcd, LNAME_mtchcd, and STRNAME_mtchcd fields.

After the records database 114 is populated with the (encrypted) match codes, the first SELECT-FROM statement of the SQL query causes the DBMS 120 to read the FNAME field, the LNAME field, the STRNO field, the STRNAME field, and the TEL_ADR field from a first of the match_src records, at step S402.

At step S404, the first SELECT-FROM statement causes the DBMS 120 to parse the first sqldq.matchCluster( ) function instance. In this example, at step S404 the value of the first argument (t2.PROVINCE) of the first sqldq.matchCluster( ) function instance is defined. However, at step S404, the value of the second argument (t2.FNAME_mtchcd ∥ t2.LNAME_mtchcd ∥ t2.STRNO ∥ t2.STRNAME_mtchcd), and the value of the third argument (t2.FNAME_mtchcd ∥ t2.LNAME_mtchcd ∥ t2.TEL_ADR) of the first sqldq.matchCluster( ) function instance are undefined. Therefore, at step S406, the DBMS 120 evaluates the second and third arguments of the first sqldq.matchCluster( ) function instance against the current match_src record.

The second argument of the first sqldq.matchCluster( ) function instance requires an evaluation of the logical AND association of the FNAME_mtchcd, LNAME_mtchcd, STRNO, and STRNAME_mtchcd fields of the current match_src record. Therefore, the current match_src record will be a member of a hierarchical data cluster (based on this deterministic cluster definition in this example) if the following cluster condition is met:
the character string of the FNAME_mtchcd field of the current match_src record matches the character string of the FNAME_mtchcd field of all other data records in the data cluster; AND
the character string of the LNAME_mtchcd field of the current match_src record matches the character string of the LNAME_mtchcd field of all other data records in the data cluster; AND
the character string of the STRNO field of the current match_src record matches the character string of the STRNO field of all other data records in the data cluster; AND
the character string of the STRNAME_mtchcd field of the current match_src record matches the character string of the STRNAME_mtchcd field of all other data records in the data cluster.

A character string that comprises the concatenation of the character strings of the FNAME_mtchcd, LNAME_mtchcd, STRNO and STRNAME_mtchcd fields of a match_src record can provide an indication of whether a match_src record satisfies these requirements.

The third argument of the first sqldq.matchCluster( ) function instance requires an evaluation of logical AND association of the FNAME_mtchcd, LNAME_mtchcd, and TEL_ADR fields of the current match_src record. Therefore, the current match_src record will be a member of the same hierarchical data cluster as defined by the second argument of the first sqldq.matchCluster( ) function) if the following alternate cluster condition is met:
the character string of the FNAME_mtchcd field of the current match_src record matches the character string of the FNAME_mtchcd field of all other data records in the data cluster; AND
the character string of the LNAME_mtchcd field of the current match_src record matches the character string of the LNAME_mtchcd field of all other data records in the data cluster; AND
the character string of the TEL_ADR field of the current match_src record matches the character string of the TEL_ADR field of all other data records in the data cluster.

A character string that comprises the concatenation of the character strings of the FNAME_mtchcd, LNAME_mtchcd, and TEL_ADR fields of a match_src record can provide an indication of whether a match_src record satisfies these latter (alternate) requirements.

Therefore, at step S406, the DBMS 120 evaluates the second argument of the first sqldq.matchCluster( ) function instance for the current match_src record by concatenating the character strings of the FNAME_mtchcd, LNAME_mtchcd, STRNO and STRNAME_mtchcd fields of the current match_src record. At step S406, the DBMS 120 also evaluates the third argument of the first sqldq.matchCluster( ) function instance for the current match_src record by concatenating the character strings of the FNAME_mtchcd, LNAME_mtchcd, and TEL_ADR fields of the current match_src record. These two concatenated character strings are passed to the first sqldq.matchCluster( ) function instance as separate arguments.

At step S408, the DBMS 120 invokes the first sqldq.matchCluster( ) function call, which causes the database query function interface 124 to pass the character strings of the evaluated arguments of the first sqldq.matchCluster( ) function instance to the data cluster engine 200 as part of the sqldq.matchCluster( ) function call. In this example, the parameters passed to the first sqldq.matchCluster( ) function instance comprise (1) a character string that consists of the PROVINCE field of the current match_src record; (2) a character string that consists of the concatenation of the character strings of the FNAME_mtchcd, LNAME_mtchcd, STRNO and STRNAME_mtchcd fields of the current match_src record; and (3) a character string that consists of the concatenation of the character strings of the FNAME_mtchcd, LNAME_mtchcd, and TEL_ADR fields of the current match_src record.

At step S410, the match signature processor 202 determines a match signature for the current match_src record from the evaluated arguments of the first sqldq.matchCluster( ) function instance for the current match_src record. Since, in this third example, the second argument that is passed to the first sqldq.matchCluster( ) function instance is consistent with the first set of logical field requirements of the first deterministic cluster definition, at step S410 the match signature processor 202 can use the concatenation of the character strings of the FNAME_mtchcd, LNAME_mtchcd, STRNO and STRNAME_mtchcd fields of the current match_src record as the first match signature of the current match_src record.

Similarly, since the third argument that is passed to the first sqldq.matchCluster( ) function instance is consistent with the second set of logical field requirements of the first deterministic cluster definition, at step S410 the match signature processor 202 can use the concatenation of the character strings of the FNAME_mtchcd, LNAME_mtchcd, and TEL_ADR fields of the current match_src record as the second match signature of the current match_src record.

As in the first and second examples, the match signature processor 202 may determine the match signatures for the current match_src record, at step S410, by applying a one-way hash algorithm to the second and third evaluated arguments of the first sqldq.matchCluster( ) function instance for the current match_src record. Also, as in the second example, the match table processor 204 maintains the match signatures for the data records in a plurality of the match signature tables 116, with each match signature table 116 being associated with a respective PROVINCE field character string. To facilitate this result, the match table processor 204 is configured to group the match signatures within the match signature tables 116 based on the character string in the PROVINCE field.

However, in contrast to the second example, each match signature table 116 comprises a plurality of match sub-tables, with each match sub-table being associated with one of the aforementioned cluster conditions. In this example, for a given PROVINCE field character string, the match table processor 204 associates one of the match sub-tables with the logical AND association of the FNAME_mtchcd, LNAME_mtchcd, STRNO, and STRNAME_mtchcd fields, and associates another one of the match sub-tables with the logical AND association of the FNAME_mtchcd, LNAME_mtchcd, and TEL_ADR fields. Therefore, for a given PROVINCE field character string, one of the match sub-tables will be associated with the first sub-cluster of the hierarchical cluster of the first deterministic cluster definition, and the other match sub-table will be associated with the second sub-cluster of the hierarchical cluster of the first deterministic cluster definition.

The match table processor 204 is also configured to populate the match signature tables 116 with match signatures such that each match signature is unique within the respective match sub-table. In this example, the match signature table 116 for a given PROVINCE field character string comprises a first match sub-table 116a that includes all of the match signatures for the first cluster condition of the first sqldq.matchCluster( ) function instance, and a second match sub-table 116b that includes all of the match signatures for the second cluster condition of the first sqldq.matchCluster( ) function instance. The match table processor 204 also maintains a cluster count value indicative of the number of entries in all of the match signature tables 116 of the first sqldq.matchCluster( ) function instance.

Therefore, at step S412, the match table processor 204 queries the first match sub-table 116a with the first match signature for the current match_src record to determine whether the first match signature for the current match_src record matches any of the match signatures previously saved in the respective first match sub-table 116a.

If the query of the respective first match sub-table 116a reveals that the first match signature has not been previously saved in the match sub-table 116a, the current match_src record will not have been previously assigned to one of the first sub-clusters of the hierarchical cluster of the first deterministic cluster definition. As a result, the match table processor 204 queries the second match sub-table 116b with the second match signature for the current match_src record to determine whether the second match signature for the current match_src record matches any of the match signatures previously saved in the respective sub-table 116b.

If the query of the respective second match sub-table 116b reveals that the second match signature has not been previously saved in the match sub-table 116b, the current match_src record will not have been previously assigned to one of the second sub-clusters of the hierarchical cluster of the first deterministic cluster definition. Therefore, processing proceeds to step S414.

At step S414, the match table processor 204 increments the cluster count value, and then updates the first match sub-table 116a with the incremented cluster count value and the first match signature for the current match_src record. The match table processor 204 also updates the second match sub-table 116b with the incremented cluster count value and the second match signature for the current match_src record. At step S420, the match table processor 204 returns the incremented cluster count value to the RDMS 120 as the clstr_id_{—}1 parameter of the first sqldq.matchCluster( )function instance.

However, if the query of the respective first match sub-table 116a, at step S412, reveals that the first match signature has already been saved in the first match sub-table 116a, the current match_src record will have been previously assigned to one of the first sub-clusters of the hierarchical cluster of the first deterministic cluster definition. Therefore, at step S418 the match table processor 204 retrieves from the first match sub-table 116a the cluster count value that was saved with the first match signature in the first match sub-table 116a. The match table processor 204 then updates the second match sub-table 116b with the retrieved cluster count value and the second match signature for the current match_src record.

Alternately, if the query of the respective second match sub-table 116b, at step S412, reveals that the second match signature has already been saved in the match sub-table 116b, the current match_src record will have been previously assigned to one of the second sub-clusters of the hierarchical cluster of the first deterministic cluster definition. Therefore, at step S418 the match table processor 204 retrieves from the second match sub-table 116b the cluster count value that was saved with the second match signature in the second match sub-table 116b. The match table processor 204 then updates the first match sub-table 116a with the retrieved cluster count value and the first match signature for the current match_src record.

Processing then proceeds to step S420 where the match table processor 204 returns the retrieved cluster count value to the RDMS 120 as the clstr_id_{—}1 parameter of the first sqldq.matchCluster( ) function instance.

Steps S404 to S420 are repeated for each subsequent sqldq.matchCluster( ) function instance. Therefore, at step S404, the first SELECT-FROM statement causes the DBMS 120 to parse the second sqldq.matchCluster( ) function instance. Since the value of the first argument (t2.PROVINCE) of the second sqldq.matchCluster( ) function instance is defined, at step S406 the DBMS 120 evaluates the second and third arguments of the second sqldq.matchCluster( ) function instance against the current match_src record.

The second argument of the second sqldq.matchCluster( ) function instance requires an evaluation of the logical AND association of the LNAME_mtchcd, STRNO, and STRNAME_mtchcd fields of the current match_src record. Therefore, the current match_src record will be a member of a hierarchical data cluster (based on this deterministic cluster definition in this example) if the following cluster condition is met:
the character string of the LNAME_mtchcd field of the current match_src record matches the character string of the LNAME_mtchcd field of all other data records in the data cluster; AND
the character string of the STRNO field of the current match_src record matches the character string of the STRNO field of all other data records in the data cluster; AND
the character string of the STRNAME_mtchcd field of the current match_src record matches the character string of the STRNAME_mtchcd field of all other data records in the data cluster.

A character string that comprises the concatenation of the character strings of the LNAME_mtchcd, STRNO and STRNAME_mtchcd fields of a match_src record can provide an indication of whether a match_src record satisfies these requirements.

The third argument of the second sqldq.matchCluster( ) function instance requires an evaluation of logical AND association of the LNAME_mtchcd, and TEL_ADR fields of the current match_src record. Therefore, the current match_src record will be a member of the same hierarchical data cluster (as defined by the second argument of the second sqldq.matchCluster( ) function) if the following alternate cluster condition is met:
the character string of the LNAME_mtchcd field of the current match_src record matches the character string of the LNAME_mtchcd field of all other data records in the data cluster; AND
the character string of the TEL_ADR field of the current match_src record matches the character string of the TEL_ADR field of all other data records in the data cluster.

A character string that comprises the concatenation of the character strings of the LNAME_mtchcd, and TEL_ADR fields of a match_src record can provide an indication of whether a match_src record satisfies these latter (alternate) requirements.

Therefore, at step S406, the DBMS 120 evaluates the second argument of the second sqldq.matchCluster( ) function instance for the current match_src record by concatenating the character strings of the LNAME_mtchcd, STRNO and STRNAME_mtchcd fields of the current match_src record. At step S406, the DBMS 120 also evaluates the third argument of the second sqldq.matchCluster( ) function instance for the current match_src record by concatenating the character strings of the LNAME_mtchcd and TEL_ADR fields of the current match_src record. These two concatenated character strings are passed to the second sqldq.matchCluster( ) function instance as separate arguments.

At step S408, the DBMS 120 invokes the second sqldq.matchCluster( ) function call, which causes the database query function interface 124 to pass the character strings of the evaluated arguments of the second sqldq.matchCluster( ) function instance to the data cluster engine 200 as part of the sqldq.matchCluster( ) function call. At step S410, the match signature processor 202 determines a match signature for the current match_src record from the evaluated arguments of the second sqldq.matchCluster( ) function instance for the current match_src record. Since, in this third example, the second argument that is passed to the second sqldq.matchCluster( ) function instance is consistent with the first set of logical field requirements of the second deterministic cluster definition, at step S410 the match signature processor 202 can use the concatenation of the character strings of the LNAME_mtchcd, STRNO and STRNAME_mtchcd fields of the current match_src record as the first match signature of the current match_src record.

Similarly, since the third argument that is passed to the second sqldq.matchCluster( ) function instance is consistent with the second set of logical field requirements of the second deterministic cluster definition, at step S410 the match signature processor 202 can use the concatenation of the character strings of the LNAME_mtchcd, and TEL_ADR fields of the current match_src record as the second match signature of the current match_src record.

As above, the match signature processor 202 may determine the match signatures for the current match_src record, at step S410, by applying a one-way hash algorithm to the second and third evaluated arguments of the second sqldq.matchCluster( ) function instance for the current match_src record.

Also, as above, each match signature table 116 maintained by the match table processor 204 comprises a plurality of match sub-tables, with each match sub-table being associated with one of the aforementioned cluster conditions. In this example, for a given PROVINCE field character string, the match table processor 204 associates one of the match sub-tables with the logical AND association of the LNAME_mtchcd, STRNO, and STRNAME_mtchcd fields, and associates another one of the match sub-tables with the logical AND association of the LNAME_mtchcd and TEL_ADR fields. Therefore, for a given PROVINCE field character string, one of the match sub-tables will be associated with the first sub-cluster of the hierarchical cluster of the second deterministic cluster definition, and the other match sub-table will be associated with the second sub-cluster of the hierarchical cluster of the second deterministic cluster definition.

The match table processor 204 is also configured to populate the match signature tables 116 with match signatures such that each match signature is unique within the respective match sub-table. Therefore, in this example, the match signature table 116 for a given PROVINCE field character string comprises a third match sub-table 116c that includes all of the match signatures for the first cluster condition of the second sqldq.matchCluster( ) function instance, and a fourth match sub-table 116d that includes all of the match signatures for the second cluster condition of the second sqldq.matchCluster( ) function instance. The match table processor 204 also maintains a cluster count value indicative of the number of entries in all of the match signature tables 116 of the second sqldq.matchCluster( ) function instance.

Therefore, at step S412, the match table processor 204 queries the third match sub-table 116c with the first match signature for the current match_src record to determine whether the first match signature for the current match_src record matches any of the match signatures previously saved in the respective third match sub-table 116c.

If the query of the respective third match sub-table 116c reveals that the first match signature has not been previously saved in the match sub-table 116c, the current match_src record will not have been previously assigned to one of the first sub-clusters of the hierarchical cluster of the second deterministic cluster definition. As a result, the match table processor 204 queries the fourth match sub-table 116d with the second match signature for the current match_src record to determine whether the second match signature for the current match_src record matches any of the match signatures previously saved in the respective sub-table 116d.

If the query of the respective fourth match sub-table 116d reveals that the second match signature has not been previously saved in the match sub-table 116d, the current match_src record will not have been previously assigned to one of the second sub-clusters of the hierarchical cluster of the second deterministic cluster definition. Therefore, processing proceeds to step S414.

At step S414, the match table processor 204 increments the cluster count value, and then updates the third match sub-table 116c with the incremented cluster count value and the first match signature for the current match_src record. The match table processor 204 also updates the fourth match sub-table 116d with the incremented cluster count value and the second match signature for the current match_src record. At step S420, the match table processor 204 returns the incremented cluster count value to the RDMS 120 as the clstr_id_{—}2 parameter of the second sqldq.matchCluster( )function instance.

However, if the query of the respective third match sub-table 116c, at step S412, reveals that the first match signature has already been saved in the match sub-table 116c, at step S414 the match table processor 204 retrieves from the third match sub-table 116c the cluster count value that was saved with the first match signature in the third match sub-table 116c. The match table processor 204 then updates the fourth match sub-table 116d with the retrieved cluster count value and the second match signature for the current match_src record.

Alternately, if the query of the respective fourth match sub-table 116d, at step S412, reveals that the second match signature has already been saved in the match sub-table 116d, at step S416 the match table processor 204 retrieves from the fourth match sub-table 116d the cluster count value that was saved with the second match signature in the fourth match sub-table 116d. The match table processor 204 then updates the third match sub-table 116c with the retrieved cluster count value and the first match signature for the current match_src record.

Processing then proceeds to step S420 where the match table processor 204 returns the retrieved cluster count value to the RDMS 120 as the clstr_id_{—}2 parameter of the second sqldq.matchCluster( ) function instance.

The INSERT INTO statement of the SQL query causes the DBMS 120 to add to the match_cluster table a new record, at step S422, that includes the character string of the FNAME field, the LNAME field, the STRNO field, the STRNAME field, the TEL_ADR field, and the cluster numbers (clstr_id_{—}1, clstr_id_{—}2) for the current match_src record.

Since the cluster count value for each deterministic cluster definition is only incremented when all of the match sub-tables for the respective deterministic cluster definition are updated with the respective (new) match signatures, the returned cluster count (clstr_id_{—}1, clstr_id_{—}2) values will be associated with only one of the match signatures in each match sub-table for the respective deterministic cluster definition.

Also, since the pre-existence of the first match signature in the first match sub-table causes the second match signature to be updated in the second match sub-table with the cluster number that was associated with the first match signature (and vice versa), the match sub-tables of the same match signature table 116 are always synchronized with each other. Therefore, the match sub-tables of the same match signature table 116 identify each data record of the records database 114 with the same cluster count value, even though each match sub-table is associated with a different match condition of the same deterministic cluster definition.

Further, since match signatures are only added to the match sub-tables for the respective deterministic cluster definition when the queries of the match sub-tables reveal that the match signatures have not already been saved in the match sub-tables, each data record of the records database 114 will be associated with only one of the match signatures in each of the match sub-tables for the respective deterministic cluster definition.

The DBMS 120 repeats steps S402 to S422 for all of the sqldq.matchCluster( ) function instances until all the data records of the records database 114 have been processed. Since each match signature is unique within the respective match sub-table, after all of the data records of the records database 114 are processed each data record will be associated with a respective match signature in its match sub-table. Further, the match_cluster table will identify the numbers (clstr_id_{—}1, clstr_id_{—}2) of the cluster of which each data record is a member. Therefore, tuples of the data records can be quickly identified by simply sorting the respective match_cluster table according to clstr_id_{—}1 or clstr_id_{—}2.

### EXAMPLE 4

### Ungrouped Data; Single Cluster Criterion; External Cluster Definition

As in the first example, in this fourth example the records database 114 has the logical name “match_src”, and the data records thereof have the following data fields:
FNAME: first name
LNAME: surname
STRNO: street number
STRNAME: street name
PROVINCE: province

Also, as in the first example, the logical field association, specified in the deterministic cluster definition, defines a data cluster as a logical AND association of the FNAME_mtchcd, LNAME_mtchcd, STRNO, and STRNAME_mtchcd fields. However, in contrast to the first example, the deterministic cluster definition is not embedded within the query to the DBMS 120, but is, instead, defined in a cluster definition table (not shown) that is referenced by the query. The cluster definition table may be maintained on the database cluster server 100, or on a computer server that is distinct from the database cluster server 100.

Again, the database cluster server 100 is configured to scan each data record of the records database 114, and to identify data clusters in these data records by populating a match signature table 116 with match signatures that are determined from an evaluation of the deterministic cluster definition. In this example, the database cluster server 100 identifies the data clusters by executing the following SQL query:

```
INSERT INTO match_cluster(
SELECT
  t1.FNAME,
  t1.LNAME,
  sqldq.matchCluster(
      “NOGROUP”,
      “CLUSTER_RULE_1”,
      t1.FNAME, t1.LNAME, t1.STRNO, t1.STRNAME) as
      clstr_id
FROM match_src t1);
```

where:
“CLUSTER_RULE_{—}1” is an external reference to the deterministic cluster definition, as encoded in the cluster definition table.

The deterministic cluster definition is referenced in this SQL query by the “CLUSTER_RULE_{—}1” argument, which, in turn, is evaluated by the match signature processor 202, based on one or more of the remaining arguments to the sqldq.matchCluster( ) function (i.e. t1.FNAME, t1.LNAME, t1.STRNO, and t1.STRNAME). This variation allows the syntax of the SQL query to remain constant, while allowing a user to alter the deterministic cluster definition simply by editing the coding of the “CLUSTER_RULE_{—}1” in the cluster definition table.

The deterministic cluster definition, that is associated with the “CLUSTER_RULE_{—}1” argument in this example, is defined in the cluster definition table by the following XML code:

```
<?xml version=“1.0” encoding=“UTF-8”?>
<MatchStream>
    <Name>Cluster_Rule_1</Name>
    <Description>Test Match</Description>
    <Version>1.1</Version>
    <Locale>EN_CA</Locale>
    <Field>
        <Id>1</Id>
        <Name>FNAME</Name>
        <NullMatch>false</NullMatch>
    </Field>
    <Field>
        <Id>2</Id>
        <Name>LNAME</Name>
        <NullMatch>false</NullMatch>
    </Field>
    <Field>
        <Id>3</Id>
        <Name>STRNO</Name>
        <NullMatch>false</NullMatch>
    </Field>
    <Field>
        <Id>4</Id>
        <Name>STRNAME</Name>
        <NullMatch>false</NullMatch>
    </Field>
    <Condition>
        <Id>1</Id>
        <Rule>FNAME+LNAME+STRNO+STRNAME</Rule>
    </Condition>
</MatchStream>
```

This evaluation of the deterministic cluster definition, based on this XML code, will be discussed below, together with the execution of the SQL query.

Referring again to FIG. 2, the SELECT-FROM statement of the SQL query causes the DBMS 120 to read the FNAME field and the LNAME field from a first of the match_src records, at step S202.

At step S204, the SELECT-FROM statement causes the DBMS 120 to parse the sqldq.matchCluster( ) function. In this example, the first argument (“NOGROUP”) of the sqldq.matchCluster( ) function is predefined. As mentioned, the second argument (“CLUSTER_RULE_{—}1”) of the sqldq.matchCluster( ) function is a reference to the deterministic cluster definition in the cluster definition table. However, the values the subsequent arguments (t1.FNAME, t1.LNAME, t1.STRNO, t1.STRNAME) of the sqldq.matchCluster( ) function are undefined. Therefore, at step S206, the DBMS 120 evaluates these subsequent arguments against the current match_src record.

At step S208, the DBMS 120 invokes the sqldq.matchCluster( ) function call, which causes the database query function interface 124 to pass the character strings of the evaluated arguments of the sqldq.matchCluster( ) function to the data cluster engine 200 as part of the sqldq.matchCluster( ) function call. In this example, the parameters passed to the sqldq.matchCluster( ) function comprise (1) a “NOGROUP” character string; (2) a “CLUSTER_RULE_{—}1” character string; and (3) the character strings of each of the FNAME, LNAME, STRNO and STRNAME fields of the current match_src record.

At step S210, the match signature processor 202 determines a match signature for the current match_src record from the evaluated arguments of the sqldq.matchCluster( ) function for the current match_src record. Since the second argument (“CLUSTER_RULE_{—}1”) of the sqldq.matchCluster( ) function references the deterministic cluster definition, the match signature processor 202 evaluates the match signature by executing the deterministic cluster definition code that is associated with the “CLUSTER_RULE_{—}1” label in the cluster definition table.

The four <Field></Field> constructs of the “CLUSTER_RULE_{—}1” deterministic cluster definition code cause the match signature processor 202 to assign the character strings of each of the FNAME, LNAME, STRNO and STRNAME fields of the current match_src record respectively to the local variables FNAME, LNAME, STRNO and STRNAME of deterministic cluster definition code.

As mentioned above, the deterministic cluster definition defines a data cluster as a logical AND association of the FNAME_mtchcd, LNAME_mtchcd, STRNO, and STRNAME_mtchcd fields. Therefore, the current match_src record will be a member of a data cluster (based on this deterministic cluster definition in this example) if the following cluster condition is met:
the character string of the FNAME field of the current match_src record matches the character string of the FNAME field of all other data records in the data cluster; AND
the character string of the LNAME field of the current match_src record matches the character string of the LNAME field of all other data records in the data cluster; AND
the character string of the STRNO field of the current match_src record matches the character string of the STRNO field of all other data records in the data cluster; AND
the character string of the STRNAME field of the current match_src record matches the character string of the STRNAME field of all other data records in the data cluster.

Since a character string that comprises the concatenation of the character strings of the FNAME, LNAME, STRNO and STRNAME fields of a match_src record can provide an indication of whether a match_src record satisfies these requirements, the <Rule></Rule> construct of the “CLUSTER_RULE_{—}1” deterministic cluster definition code causes the match signature processor 202 to generate a character string from the concatenation of the character strings of the FNAME, LNAME, STRNO and STRNAME fields of the current match_src record.

Although the match signature processor 202 can use this concatenated character string as the match signature of the current match_src record, preferably the match signature processor 202 determines the match signature for the current match_src record, at step S210, by applying a one-way hash algorithm to the concatenated character string.

At steps S212 to S220, the match table processor 204 populates the match signature table 116 with match signatures such that each match signature is unique within the match signature table 116, as discussed above with reference to the first example.

The INSERT INTO statement of the SQL query causes the DBMS 120 to add to the match_cluster table a new record, at step S222, that includes the character string of the FNAME field, the LNAME field, and the cluster number (clstr_id) for the current match_src record. As above, the DBMS 120 repeats steps S202 to S222 until all the data records of the records database 114 have been processed.

Although, in the examples of FIGS. 3, 4 and 5, the cluster identifications are performed in batch mode, as mentioned the database cluster server 100 may also be configured to process new data records, in real time, as they are prepared to be entered into the records database 114. Further, although the data clustering engine 200 typically maintains the match sub-tables in the RAM 104, the data clustering engine 200 may save a persistent copy of the match sub-tables in the non-volatile memory 102 after each data record is processed (e.g. at step S420). As a result, the data clustering engine 200 will be able to process each new data record as it is received from the DBMS 120, without having to first re-populate the match sub-tables with the match signatures for the data records already saved in the records database 114.

The Applicant conducted the following performance benchmark analysis of the database cluster server 100:

Data Clustering Engine Performance

Hardware Platform: Apple MacBook Pro 2.4 GHz Dual Core, 4 GB RAM, 160 GB (5400 rpm) HD

database size: 2 million records

cluster definition: (first_name AND last_name AND street_address) OR (first_name AND last_name AND telephone_number)

match code creation (one time operation, using fuzzy standardization and phonetic normalization): 840 s

data cluster analysis: 140 s

duplicate record detection: 5.23% (of 2 million records)

Conventional Duplicate Detection

Hardware Platform: IBM dual-2.2 GHz p5, 8 GB RAM, network storage array

database size: 2 million data records

cluster definition #1: first_name AND last_name AND street_address

cluster definition #2: first_name AND last_name AND telephone_number

match code creation: not applicable

data cluster analysis (execution of both cluster definitions in sequence): 4200 s

duplicate record detection (using distance-based deterministic algorithm): 5.21% (of 2 million records)

This invention is defined by the claims appended hereto, with the foregoing description being merely illustrative of the preferred embodiment of the invention. Persons of ordinary skill may envisage certain modifications to the described embodiments which, although not explicitly suggested herein, do not depart from the scope of the invention, as defined by the appended claims.

1. A method of managing a plurality of data records, comprising:
(i) determining a match signature for one record of the plurality of records by evaluating a deterministic cluster definition against the one record, each said record of the plurality of records comprising a plurality of fields, the deterministic cluster definition comprising a logical association of the fields and defining at least one data cluster of the plurality of the data records;
(ii) searching a match table for a table entry matching the match signature, the match table comprising at least one previously-entered match signature, each said previously-entered match signature being unique within the match table and being determined by evaluating the deterministic cluster definition against another one of the records of the plurality of records, each said another one record being associated with a respective one of the previously-entered match signatures via the deterministic cluster definition; and
(iii) determining membership of the one record in the cluster, the membership determining comprising updating the match table with the match signature for the one record upon the match table search locating no previously-entered match signature in the match table matching the match signature for the one record.

2. The method according to claim 1, wherein the logical association comprises at least one of a logical AND association of at least two of the fields, and a logical OR association of at least two of the fields.

3. The method according to claim 2, wherein the cluster comprises a hierarchical cluster, and the match table comprises a plurality of match sub-tables, and at least one of the match sub-tables is uniquely associated with a respective one of the logical AND associations.

4. The method according to claim 3, wherein each of the match sub-tables is populated with at least one of the previously-entered match signatures, each of the previously-entered match signatures of the respective match sub-table being determined from a respective one of the logical AND associations via the deterministic cluster definition and being maintained in the match sub-table that is uniquely associated with the one logical AND association.

5. The method according to claim 4, wherein the match signature determining comprises evaluating a respective one of the logical AND associations against the one record, and the match table searching comprises for each said determined match signature of the one record searching the respective match sub-table for a sub-table entry matching the determined match signature.

6. The method according to claim 1, wherein the match signature determining comprises evaluating the cluster definition without probabilistic matching.

7. The method according to claim 1, wherein the membership determining comprises updating the match table without sorting the plurality of data records.

7. The method according to claim 6, wherein the match signature determining comprises, prior to the cluster definition evaluating, encoding character strings contained in the fields to reduce an edit distance between similar ones of the strings.

8. The method according to claim 7, wherein the character string encoding comprises phonetic match encoding.

9. The method according to claim 7, wherein the character string encoding comprises fuzzy standardization for reducing an impact of typographical errors in the cluster definition evaluating.

10. The method according to claim 9, wherein the character string encoding further comprises phonetic normalization for evaluating a phonetic similarity between the strings.

11. The method according to claim 1, wherein the match table includes a plurality of previously-allocated cluster numbers, each said previously-allocated cluster number being uniquely associated with a respective one of the previously-entered match signatures, and the method further comprises:
(iv) in response to a query associated with the deterministic cluster definition, assigning one of a new cluster number and a cluster number previously-allocated in the match table to the match signature for the one record in accordance with an outcome of the search; and
(v) replying to the query with the assigned cluster number.

12. The method according to claim 11, wherein the assigned cluster number is persistently assigned to the match signature for the one record, the persistently associating comprising maintaining the assignment in the match table subsequent to the membership determining.

13. A computer-readable medium carrying computer processing instructions which, when executed by a computer, cause the computer to perform the following steps:
determine a match signature for one record of a plurality of records by evaluating a deterministic cluster definition against the one record, each said record of the plurality of records comprising a plurality of fields, the deterministic cluster definition comprising a logical association of the fields and defining at least one data cluster of the plurality of the data records;
search a match table for a table entry matching the match signature, the match table comprising at least one previously-entered match signature, each said previously-entered match signature being unique within the match table and being determined by evaluating the deterministic cluster definition against another one of the records of the plurality of records, each said another one record being associated with a respective one of the previously-entered match signatures via the deterministic cluster definition; and
determine membership of the one record in the cluster, the membership determining comprising updating the match table with the match signature for the one record upon the match table search locating no previously-entered match signature in the match table matching the match signature for the one record.

14. A data cluster server comprising:
a database comprising a plurality of records, each said record of the database comprising a plurality of fields;
a match table comprising at least one previously-entered match signature, each said previously-entered match signature being unique within the match table and being determined by an evaluation of a deterministic cluster definition against a respective record of the database, the deterministic cluster definition comprising a logical association of the fields and defining at least one data cluster, each said record of the database being associated with a respective one of the previously-entered match signatures via the deterministic cluster definition;
a data clustering engine configured for communication with the database and the match table, the data clustering engine being configured to determine a match signature for a data record received at the data clustering engine by evaluating the deterministic cluster definition against the received data record, the data clustering engine being further configured to search the match table for a previously-entered match signature matching the match signature determined for the received data record, and to update the match table with the match signature for the received data record upon the match table search locating no previously-entered match signature in the match table matching the match signature for the received data record.

15. The data cluster server according to claim 14, wherein the match table includes a plurality of previously-allocated cluster numbers, each said previously-allocated cluster number being uniquely associated with a respective one of the previously-entered match signatures.

16. The data cluster server according to claim 15, wherein the data clustering engine is configured to assign to the match signature for the received record one of a new cluster number and a cluster number previously-allocated in the match table to the match signature, the data clustering engine being configured to assign the cluster number in accordance with an outcome of the search and in response to a query associated with the deterministic cluster definition, the data clustering engine being further configured to reply to the query with the assigned cluster number.

17. A method of managing a plurality of records, each said record comprising a plurality of fields, the method comprising:
determining a match signature for each said record of the plurality of records by evaluating a deterministic cluster definition against each said record, the deterministic cluster definition comprising a logical association of the fields and defining at least one cluster of the plurality of the records; and
identifying the data clusters amongst the plurality of records by populating a match table with the match signatures, each said match signature being unique within the match table, each said record of the plurality of records being associated with a respective one of the match signatures populated in the match table.

18. The method according to claim 17, wherein the logical association comprises at least one of a logical AND association of at least two of the fields, and a logical OR association of at least two of the fields.

19. The method according to claim 17, wherein the logical association comprises a logical AND association of at least two of the fields, the match table comprises a plurality of match sub-tables, and at least one of the match sub-tables is uniquely associated with a respective one of the logical AND associations.

20. The method according to claim 19, wherein each of the match sub-tables is populated with at least one of the match signatures, each of the match signatures being determined from a respective one of the logical AND associations via the deterministic cluster definition and being maintained in the match sub-table that is uniquely associated with the one logical AND association.

21. The method according to claim 20, wherein the match signature determining comprises, prior to the cluster definition evaluating, encoding character strings contained in the fields to reduce an edit distance between similar ones of the strings.

22. The method according to claim 21, wherein the character string encoding comprises fuzzy standardization for reducing an impact of typographical errors in the cluster definition evaluating.

23. The method according to claim 22, wherein the character string encoding further comprises phonetic normalization for evaluating a phonetic similarity between the strings.

24. The method according to claim 21, wherein the match signature determining comprises evaluating a respective one of the logical AND associations against the encoded character strings of the one record.

25. The method according to claim 24, wherein the data cluster identifying comprises for each said determined match signature of the one record searching the respective match sub-table for a sub-table entry matching the determined match signature, and updating the respective match sub-table with the match signature for the one record upon the match sub-table search locating no match signature in the match sub-table matching the match signature for the one record.

26. A computer-readable medium carrying computer processing instructions which, when executed by a computer, cause the computer to perform the following steps:
determine a match signature for each said record of a plurality of records by evaluating a deterministic cluster definition against each said record, the deterministic cluster definition comprising a logical association of the fields and defining at least one data cluster of the plurality of the records; and
identify the data clusters amongst the plurality of records by populating a match table with the match signatures, each said populated match signature being unique within the match table, each said record of the plurality of records being associated with a respective one of the match signatures populated in the match table.

27. A data clustering engine comprising:
a match signature processor configured for communication with a database comprising a plurality of records, each said record of the database comprising a plurality of fields, the match signature processor being configured to determine a match signature for each record of the plurality of records by evaluating a deterministic cluster definition against each said record, the deterministic cluster definition comprising a logical association of the fields and defining at least one data cluster of the plurality of the data records; and
a match table processor coupled to the match signature processor, the match signature processor being configured for communication with a match table and to identify the data clusters by populating the match table with the match signatures such that each said populated record is unique within the match table, and each said record of the plurality of records is associated with a respective one of the match signatures populated in the match table.
